(19) United States
(12) Patent Application Publication
(10) Pub. No.: US 2013/0331536 A1
(43) Pub. Date: Dec. 12, 2013

(54) Method of Producing Composite Materials

(71) Applicants: Pauliina Mikkonen, (US); Ulla Laulumaa, Rajamaki (FI); Pia Mikkonen, (US)

(72) Inventors: Mika Harkonen, Vtt (FI); Lisa Wikstrom, Vtt (FI); Kalle Nattinen, Tampere (FI); Leena Nurmi, Vtt (FI); Hannu Mikkonen, Vtt (FI)

(73) Assignee: TEKNOLOGIAN TUTKIMUSKESKUS VTT, VTT (FI)

(21) Appl. No.: 13/977,926

(22) PCT Filed: Jan. 5, 2012
(86) PCT No.: PCT/FI2012/050012

§ 371 Date: Aug. 21, 2013

(30) Foreign Application Priority Data
Jan. 5, 2011 (FI) 20115007

(51) Int. Cl. C08G 67/00

(52) U.S. Cl. CPC C08G 67/00
USPC 527/300

(57) ABSTRACT

A method of producing a material comprising nanocellulose and a polymer, comprising carrying out in-situ, ring opening of polymerisation of dry nanocellulose dispersed in a monomer to produce said material. The material can be used as a reinforcing additive for plastics, for example in the form of a plastics masterbatch.

The present invention concerns a method according to the preamble of claim 1 of producing composites comprising nanocellulose, such as nanofibrillated cellulose (NFC), and polymers.

Dispersing nanocellulose to organic polymer has proven to be very challenging. It has been shown that good dispersion in polymer matrix requires special modification of the NFC surface. However even strong hydrophobisation of NFC surface does not necessarily lead to good nanodispersion, but NFC fibrils tend to agglomerate when blended to polymer.

This challenge is even more pronounced due to fact that NFC is normally produced as a 2% dispersion or gel in water and replacing water with some material more compatible with thermoplastics has been a major challenge.

These have been major obstacles for application NFC as reinforcing fibre for thermoplastic NFC composites and solving this is a research topic for many groups globally.

The commercial potential of solving the dispersion problem is huge especially when reinforcing biopolymers.

It is an aim of the present invention to eliminate at least a part of the problems relating to the art and to provide a novel technical solution of producing

In the present invention good distribution of NFC in polymer has been achieved by so called in-situ polymerisation of NFC with e-caprolactone (CL), resulting in a so called NFC-g-PCL copolymer. The material is made by ring opening polymerisation on dry NFC dispersed in CL.

The basic principle and idea of grafting an NFC surface with PCL is discussed by Lönnberg et al. (Lönnberg, H., Fogelström, L., Azizi Samir, M. A., Berglund, L., Malmström, E., Hult, A., Surface grafting of microfibrillated cellulose with poly(ε-caprolactone-Synthesis and characterization, European Polymer Journal 44 (2008) 2991-2997) .

In the known art, a separate co-initiator like benzyl alcohol was used which favours formation of considerable amount of homopolymer

Similarly, in US Patent Application Publication US 2011/0196094, grafting of PLA on nanocrystalline cellulose (NCC) is disclosed. The polymerization of the PLA is carried out in an organic solvent, for example dimethyl sulfoxide (DMSO). Formation of up to 70% of PLA homopolymers is indicated, although the publication states that typically 85% of the PLA would be grafted to the NCC.

The present synthetic approach disclosed differs from known methods for example in the respect that no separately added co-initiator (e.g. low molecular weight alcohol) is employed. In one embodiment, nanofibrillated cellulose is applied, that forms enforcing network within the polymer matrix. Further, in one embodiment, polymerization is carried out with the nanocellulose dispersed in the monomer, such as CL, rather than in an organic solvent. In another embodiment, nanofibrillated cellulose is dispersed in either a monomer or in a mixture of the monomer and an inert organic solvent.

The present invention provides for the use of in-situ polymerised NFC-g-PCL or nanofibrillated cellulose grafted with polylactide (NFC-g-PLA) as reinforcing additive for plastics. In another embodiment, the present invention provides for the use of nanofibrillated cellulose as a rheology modifier of polymer melts, e.g. as a reinforcing processing additive.

More specifically, the present method is characterized by what is stated in the characterizing part of claim 1.

The use according to the invention is characterized by what is stated in claim 12.

Considerable advantages are obtained by the invention.

The presented synthesis ensures efficient grafting. The amounts of homopolymers formed are small, if any, and it has turned out that removal of any free homopolymer and adsorbed polymer may not even be required for the use of the grafted compositions.

In the new compositions, with NFC contents as low as <1%, calculated from the mass of the composition, rheology and microscopy give strong indications of good nanodispersion. Polymer melt shows notably increased melt strength and, in addition, the mechanical properties are significantly increased compared to those of PCL homopolymers.

The orientation of the material has shown surprisingly good impact strength properties.

The novel method and compositions are interesting for—and the present invention has great potential in—the production of extruded and oriented products, such as (bio)polymer films, coatings and fibres. This is based on the finding that the present NFC-g-PCL material containing small, up to 5% (typically <1%) amounts of NFC, calculated on the total mass of the composition, has a surprising combination of properties that are important for plastic film preparation and end use. The NFC network formed in the polymer simultaneously increase the melt strength and mechanical properties of the polymer. The notably increased melt strength for the otherwise linear PCL polymer is expected to be advantageous for cast film, blown film and extrusion coating processes as well pipe and profile extrusion and blow moulding.

In addition to the processing additive effect, the NFC network also reinforces the materials and thus increases mechanical properties such a stiffness, tensile strength and creep resistance. Especially surprising was the highly positive effect on impact strength. Improvements of properties, in particular mechanical properties, are notable compared to pure PCL or if 2% NFC is solution blended to PCL.

Next, the new technology and the advantages obtained thereby will be examined more closely with the aid of a detailed description and with reference to the attached drawings.

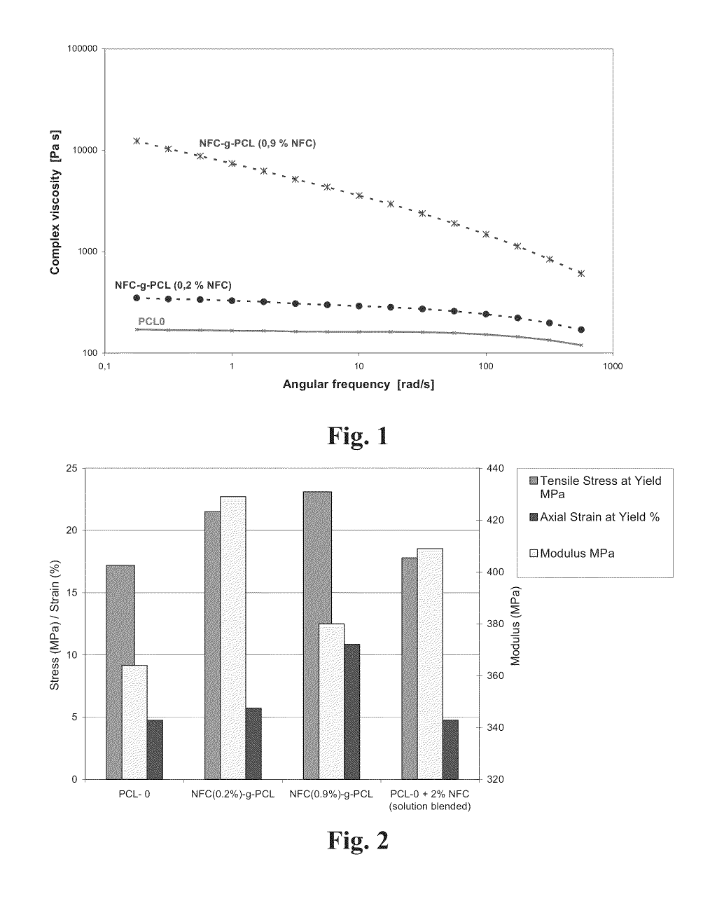

FIG. 1 shows that the shear thinning effect can be seen in the NFC-g-PCL polymer with 0.9% of NFC;

FIG. 2 shows the increase in mechanical properties of the NFC-g-PCL polymer can be seen in tensile stress and strain; improvements being clear compared to pure PCL or if 2% NFC is solution blended to PCL; and

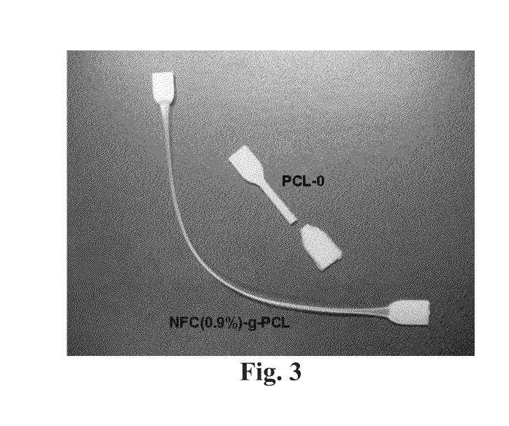

FIG. 3 show the mechanical properties for samples of injection moulded pure PCL (PCL-0) and NFC-g-PCL (0.9% NFC) after tensile testing in the room temperature. PCL-0 has broken and NFC-g-PCL has stretched.

It should be pointed out that the technology is described with particular reference to nanofibrillated cellulose (NFC). As mentioned below, this is a particularly preferred embodiment. However, the technology is also applicable to other nanocellulose materials. Similarly, caprolactone is mostly used as a specific example of the monomers although other monomers can be employed as well.

The term “nanofibrillated cellulose” (NFC) refers to cellulosic fibrils disintegrated from plant cell walls (e.g. wood pulp) through high shearing forces. NFC can be prepared e.g. by mechanical refining, followed by passing the pulp slurry through a high-pressure homogenizer. The NFC preparation process yields a highly entangled fibril network, that typically has a wide size distribution down to nanoscale fibrils.

Thus, “nanocellulose” in this document refers to any cellulose fibers with an average (smallest) diameter (by weight) of 10 micrometer or less, preferably 1 micrometer or less, and most preferably 200 nm or less. The “cellulose fibers” can be any cellulosic entities having high aspect ratio (preferably 100 or more, in particular 1000 or more) and in the above-mentioned size category. These include, for example, products that are frequently called fine cellulose fibers, microfibrillated cellulose (MFC) fibers and cellulose nanofibers (NFC). Common to such cellulose fibers is that they have a high specific surface area, resulting in high contact area between fibers in the end product. As a result dispersed NFCs will form networks within polymer matrices.

As far as manufacture of nanocellulose is concerned, we refer to methods known per se, for example, as disclosed in US 2007/0207692, WO 2007/91942, JP 2004204380 and U.S. Pat. No. 7,381,294.

As discussed above, in the present invention good distribution of NFC in polymer has been achieved by so called in-situ polymerisation of NFC with a ring-polymerizable monomer, such as e-caprolactone (CL). This results in NFC fibrils that are heavily grafted with the polymerized monomer, such as PCL polymers, enabling good nanodispersion and formation of NFC network in said polymers. The resulting material can be called an NFC-g-PCL copolymer or, in the case of lactide, NFC-g-PLA copolymer. Generally, the material can be called a nanofibrillated cellulose grafted with monomer applicable for ring opening polymerisation, NFC-g-ROP.

The initial step before copolymerization includes transfer of NFC from water dispersion to an inert solvent, such as toluene, which can be then readily mixed with the CL monomer. Removal of toluene by vacuum distillation leaves NFC dispersed in CL monomer. Toluene also forms azeotrope with water which is advantageous for drying, resulting in favourable conditions of graft-copolymerization over homopolymerisation of PCL.

Any other solvent than toluene can also be used, provided that any solvent traces do not distress intended polymerisation. Thus the aim of the initial step discussed above is to replace water with inert solvent. In addition to toluene, a number of organic aprotic solvents can be used, for example acetone, n-butyl acetate, and benzene.

In the following step, polymerization of the monomer is carried out in the presence of the dispersed NFC material. The polymerization is performed in situ by ring opening polymerization on dry NFC dispersed in CL or similar monomer.

The nanocellulose, such as nanofibrillated cellulose, subjected to polymerization typically contains less than 10%, preferably less than 1% of water, calculated from the mass of the nanocellulose.

The reaction mixture formed by nanocellulose and monomer contains less than 1.0%, advantageously less than 0.5%, in particular less than 0.1% of water.

According to one embodiment, the present material is made by opening polymerisation on dry NFC (<0.1% of water) dispersed in CL.

The polymerization is carried out at conditions known per se for polymerization of the monomers. Typically the polymerization is carried out at elevated temperature which is, depending on the monomer about 80 to 250° C., preferably about 100 to 200° C., in particular about 100 to 180° C., and for a period of time of about 0.5 to 24 hours.

The ring-opening polymerization is carried out in the presence of a catalyst, preferably a homogeneous catalyst, in particular tin octoate. Other examples of catalysts are tin and aluminium alkoxides.

According to a preferred embodiment, the nanocellulose is primarily dispersed in the monomer phase.

In order to keep the viscosity suitable, in one embodiment the monomer may contain a solvent which is inert towards the nanofibrillated cellulose and, preferably, towards the polymer. Such a solvent can be of the kind described above.

The amount of any solvent in polymerization is 0 up to 50% by weight of the monomer.

By the above method steps, a composition is obtained which contains up to about 5%, in particular 3% or less, typically about 0.1 to 1.5%, by mass of nanocellulose in the polymer which results from the polymerization of the monomer (e.g. CL).

To take nanofibrillated cellulose as an example, the preparation of a polymer nanodispersion composition is typically carried out with a low but significant 1% concentration of nanofibrils. However, concentrations of 0.2% nanofibrils are still effective. The observation of very notable increase in impact strength, probably caused by favourable orientation of the dispersed nanocellulose network is new.

In addition to the above embodiments, the use of the material as a reinforcing processing additive master batch for thermoplastic extrusion products is a particularly interesting embodiment. In that case, it may be advantageous to have a higher concentration of the nanocellulose in the polymer.

Despite the anticipated high costs per kg of manufactured NFC-g-PCL, the increase of the target matrix material cost is low because already very low concentrations give significant improvement in properties. Additionally, the low additive percentage helps to avoid problems related to high filler contents of typical reinforcements (20-50%). With low percentage, the processing parameters and e.g. mould design need not be altered. Therefore the addition into existing products and processes can be readily achieved and market penetration is quick and uncomplicated.

Market penetration is further supported by the relatively low initial performance of the pure, non-reinforced biopolymers. The existing additives for reinforcement purpose include materials such as cellulose fibres, unmodified nanocellulose, carbon nanotubes. Each of these has one or more significant drawbacks:
The addition cellulosic fibres result in reduced impact strength and high filler contents are required, which compromises the processibility.
Unmodified nanocellulose is available only as a 1-2% dispersion which cannot be dispersed in the melt, and furthermore, which is not chemically compatible with the commercial biopolymers.
Carbon nanotubes are not compatible with the polymeric matrix without compatibilisation. The potential compatibilisation adds to the price of the already costly carbon nanotubes. Furthermore, by addition of the synthetic, oil based carbon nanotubes, the green and biobased composition of the target biopolymers is lost.

The technology described in this disclosure is so far one of the very few applications with immediate commercial potential within the nanocellulose (thermoplastic) composite research area. The applicability to several materials and processes of the plastics processing companies of, for example, the bioplastics industry, is very interesting.

As described earlier, CL can be replaced by lactide (LA) and then this technique is applicable for combined reinforcing and processing additive for PLA films and fibres. This may even be of higher potential than PCL-materials. In addition this principle of in-situ polymerisation can be later extended to other polymerisation techniques than ROP.

Turning now to the drawings, which illustrate the rheology and mechanical properties of in-situ polymerised NFC-g-PCL, it can be noted that a good distribution of NFC in polymer has been achieved by the above discussed method. The NFC network formed in the polymer increases the melt strength and mechanical properties of the polymer. A strong indication of good dispersion can be seen in the rheology of the polymer.

Rheology measurements show the shear thinning effect of the NFC-g-PCL polymer (FIG. 1). The increase in mechanical properties of the NFC-g-PCL polymer can be seen in tensile stress, strain and especially in impact strength. Tensile stress and strain improvements are notable compared to pure PCL or if 2% NFC is solution blended to PCL (FIG. 2). Impact strength (unnotched) increased clearly in the in situ polymerized NFC-g-PCL sample compared to PCL-0 sample when the NFC content was 0.9%.

An indirect proof of good nanodispersion can be seen in the properties of copolymers dissolved both in THF and toluene: viscosity of NFC-g-PCL dissolved in toluene was 10 times higher compared to homopolymer solutions prepared under same conditions.

NFC(0.9%)-g-PCL samples had high impact strength (Table 1).

TABLE 1
Impact strength (unnotched) increased notably in the insitu
polymerized NFC-g-PCL sample compared to PCL-0 sample
when the NFC content was 0.9%

| | Impact Strenght | Standard |
|---|---|---|
| | [kJ/m2] | deviation |
| PCL-0 | 22.2 | 4.5 |
| NFC (0.2%)-g-PCL | 22.3 | 18.4 |
| NFC (0.9%)-g-PCL | no break | |

FIG. 3 shows that samples of injection moulded pure PCL (PCL-0) and NFC-g-PCL (0.9% NFC) after tensile testing in the room temperature. PCL-0 has broken and NFC-g-PCL has stretched.

As mentioned above, the present invention is not limited to CL, but all others monomers applicable for ring opening polymerisation (ROP) can be applied, such as lactide, and copolymers of these. The idea of reinforcing processing additive is especially interesting for PLA films and fibres.

Suitable applications for the present compositions are therefore in high strength PLA or PCL films and fibres; in PLA extrusion coated packaging board and in biodegradable plastic bags (having properties of improved strength and creep resistance).

The above mentioned nanocellulose material primarily consists of so-called nanofibrillated cellulose (NFC) or microfibrillated cellulose (MFC). However, the technology described is also applicable to nanocellulose as such, including nanocrystalline cellulose (NCC, i.e. “whiskers”), microcrystalline cellulose (MCC), and bacterial cellulose (BC).

The fibrillated products are typically produced in water to give gel or viscous compositions and dispersions having solids contents of approximately 1-4 wt-% in water. The aqueous dispersions are, as disclosed above, preferably exchanged to an organic solvent. However, it is also possible to apply the nanocellulose in the form of dried redispersible granules.

### EXAMPLE 1

### Solvent Exchange Process of NFC Dispersion from Water to Toluene

100 g of NFC water dispersion was combined with 1000 ml of acetone. NFC sedimentation occurred within 24 h, until approximately 100 ml balance volume was reached. At this point clear, moist acetone phase was removed and replaced with 900 ml of dry acetone. After another sedimentation step, the obtained NFC dispersion in acetone was concentrated with a ceramic filter. The flow of acetone through the filter stopped when the viscosity of the NFC dispersion increased.

The solvent of the NFC dispersion in acetone was consequently exchanged to toluene with similar sedimentation and concentration steps. Water content of the NFC solvent dispersions was monitored by Karl-Fischer titration.

TABLE 2
Description of NFC transfer from water dispersion to toluene dispersion

| NFC gel 100 g | | | | % water in NFC |
|---|---|---|---|---|
| in water | acetone | time | Concentration to | dispersion |
| Step 1 - mixing | +1000 ml | 24 h | 100 ml volume | |
| Step 2 - mixing | +900 ml | 24 h | 100 ml volume | |
| Step 3 | Washing with acetone on | | | 0.9 |
| | ceramic filter | | | |
| NFC gel 80 g | | | | % water in NFC |
| in acetone | toluene | time | Concentration to | dispersion |
| Step 1 - mixing | +1000 ml | 24 h | ~50 ml volume | |
| Step 2 - mixing | +950 ml | 24 h | ~50 ml volume | |

| | | |
|---|---|---|
| Step 3 | Washing with toluene on | 0.1 |
| | ceramic filter | |

### EXAMPLE 2

### Grafting of NFC with ε-caprolactone

Typically, 500 g of NFC toluene dispersion with NFC content 0.9 w % and water content <0.1 w % was inserted into the reactor. 500 g of CL was added gradually. The toluene was distilled away from the mixture at 120° C. in vacuum. The reactor was set under N₂ flow and 1.7 g of Sn(Oct)₂ catalyst was added in 5 ml of toluene. The temperature was increased to 170° C., and the reaction mixture was left stirring for 16 h. Afterwards, the reaction mixture was treated in vacuum at 170° C. to remove the un-reacted monomers.

1. A method of producing a material comprising nanocellulose and a polymer, comprising carrying out in-situ, ring opening of polymerization on nanocellulose dispersed in a monomer to produce said material.

2. The method according to claim 1, wherein the nanocellulose is nanofibrillated cellulose (NFC).

3. The method according to claim 1, wherein the nanocellulose is dry and contains less than 10% of water, calculated from the mass of the nanocellulose.

4. The method according to claim 1, wherein the reaction mixture formed by nanocellulose and monomer contains less than 1.0% of water.

5. The method according to claim 1, wherein the polymerization is carried out in the absence of a separately added co-initiator.

6. The method according to claim 1, wherein the polymerization is carried out in the absence of an inert solvent.

7. The method according to claim 2, wherein the nanofibrillated cellulose is subject to in-situ ring-opening polymerization of monomers which is carried out in the presence of an inert solvent.

8. The method according to claim 1, wherein the material comprises less than 5% nanofibrillated cellulose, calculated from the mass of the material.

9. The method according to claim 1, wherein the monomer is e-caprolactone or another monomer applicable for ring opening polymerization.

10. The method according to claim 1, wherein a nanofibrillated cellulose grafted with monomer applicable for ring opening polymerization, NFC-g-ROP, is produced.

11. The method according to claim 1, wherein the ring-opening polymerization is carried out in the presence of a catalyst.

12. (canceled)

13. (canceled)

14. (canceled)

15. (canceled)

16. (canceled)

17. (canceled)
